(19) United States
(12) Patent Application Publication
(10) Pub. No.: US 2021/0072818 A1
(43) Pub. Date: Mar. 11, 2021

(54) INTERACTION METHOD, DEVICE, SYSTEM, ELECTRONIC DEVICE AND STORAGE MEDIUM

(71) Applicant: BAIDU ONLINE NETWORK TECHNOLOGY (BEIJING) CO., LTD., Beijing (CN)

(72) Inventor: Yang Liu, Beijing (CN)

(21) Appl. No.: 16/859,688

(22) Filed: Apr. 27, 2020

(30) Foreign Application Priority Data
Sep. 11, 2019 (CN) 201910859793.5

(51) Int. Cl. G06F 3/01; H04W 4/029; H04N 9/31

(52) U.S. Cl. CPC G06F 3/011; H04N 9/3147; H04W 4/029

(57) ABSTRACT

The present disclosure discloses an interaction method, device, system, an electronic device and a storage medium, and relates to the field of multimedia technology, a specific implementation is: by collecting user information of a user in an environment, the user information includes a user position and a user behavior; determining, in a preset environment modeling, a user modeling position where the user is according to the user position; determining a display modeling position of an audio and video display device in the environment modeling according to the user behavior; and controlling the audio and video display device to perform a display of interaction information in the environment according to the display modeling position. The interaction effect with the user is better and the interactivity is stronger.

### CROSS-REFERENCE TO RELATED APPLICATION

This application claims priority to Chinese Patent Application No. 201910859793.5, filed on Sep. 11, 2019, which is hereby incorporated by reference in its entirety.

### TECHNICAL FIELD

The present disclosure relates to multimedia technologies, and in particular, to an interaction method, a device, a system, an electronic device, and a storage medium.

### BACKGROUND

With the development of intelligent, intelligent products that can interact with users gradually enter people's lives.

Interaction manners of existing intelligent interaction products are implemented generally based on user gestures or voice. The interaction products provide a user with a display of interaction information by collecting gestures or voice of the user and performing corresponding process on the gestures or voice. For example, a speaker with a screen can respond to an instruction initiated through voice by the user to display corresponding information on the screen it carries; for another example, an intelligent TV can perform a display on its screen by capturing user gestures and determining corresponding programs according to the user gestures.

However, since the interaction products can only perform the display of the interaction information through a display screen or a sound device at a fixed position, to accomplish an interaction with the user, the information display in such an interaction manner is highly directional and less flexible. Once a position of the user changes, the interaction products cannot display the interaction information to the user.

### SUMMARY

In view of the above technical problems, the present disclosure provides an interaction method, a device, a system, an electronic device, and a storage medium.

In a first aspect, the present disclosure provides an interaction method, including:

collecting user information of a user in an environment, the user information includes a user position and a user behavior;

determining, in a preset environment modeling, a user modeling position where the user is according to the user position;

determining a display modeling position of an audio and video display device in the environment modeling according to the user behavior; and

controlling the audio and video display device to perform a display of interaction information in the environment according to the display modeling position.

In a second aspect, the present disclosure provides an interaction device, including:

a collecting module, configured to collect user information of a user in an environment, the user information includes a user position and a user behavior;

a processing module, configured to determine, in a preset environment modeling, a user modeling position where the user is according to the user position; and further configured to determine a display modeling position of an audio and video display device in the environment modeling according to the user behavior; and

a controlling module, configured to control the audio and video display device to perform a display of interaction information in the environment according to the display modeling position.

In a third aspect, the present disclosure provides an interaction system, including: an interaction device and an audio and video display device;

where the interaction device is configured to execute methods of any one of the foregoing for the audio and video display device to perform a display of interaction information in an environment based on a control of the interaction device.

In a fourth aspect, the present disclosure provides an electronic device including:

at least one processor; and

a memory communicated and connected with the at least one processor; where:

the memory stores instructions executable by the at least one processor, and the instructions are executed by the at least one processor, so that the at least one processor can execute methods of any one of the foregoing.

In a fifth aspect, the present disclosure provides a non-transitory computer-readable storage medium storing computer instructions, the computer instructions are used to cause a computer to execute methods of any one of the foregoing.

The interaction method, device, system, the electronic device and the storage medium provided by the present disclosure, by collecting user information of a user in an environment, the user information includes a user position and a user behavior;

determining, in a preset environment modeling, a user modeling position where the user is according to the user position; determining a display modeling position of an audio and video display device in the environment modeling according to the user behavior; and controlling the audio and video display device to perform a display of interaction information in the environment according to the display modeling position, the manner for the displayed interaction information of the interaction method is no longer restricted to a screen or a speaker fixed on an interaction device, but can determine the display modeling position of the interaction information based on the user behavior and the user position of the user, and then use the audio and video display device in the environment to perform a display of a corresponding position for the interaction information, its interaction effect with the user is better and the interactivity is stronger.

Other effects of the above manners will be illustrated in combination with specific embodiments hereinafter.

### BRIEF DESCRIPTION OF DRAWINGS

The drawings are for better understanding of the present scheme, and do not constitute a limitation on the present disclosure.

FIG. 1 is a schematic structural diagram of an interaction system provided by the present disclosure;

FIG. 2 is a schematic flowchart of an interaction method provided by the present disclosure;

FIG. 3 is a first display effect diagram of interaction information of an interaction method provided by the present disclosure;

FIG. 4 is a second display effect diagram of interaction information of an interaction method provided by the present disclosure;

FIG. 5 is a third display effect diagram of interaction information of an interaction method provided by the present disclosure;

FIG. 6 is a schematic flowchart of another interaction method provided by the present disclosure;

FIG. 7 is a schematic structural diagram of an interaction device provided by the present disclosure;

FIG. 8 is a schematic structural diagram of hardware of an interaction system provided by the present disclosure; and

FIG. 9 is a block diagram of an electronic device for implementing an interaction method of an embodiment of the present disclosure provided by the present disclosure.

### DESCRIPTION OF EMBODIMENTS

Exemplary embodiments of the present disclosure will be illustrated in combination with the accompanying drawings in the following, which include various details of the embodiments of the present disclosure to facilitate understanding, and they should be considered as merely exemplary. Therefore, those of ordinary skill in the art should recognize that various changes and modifications can be made to the embodiments described herein without departing from the scope and spirit of the present disclosure. Also, for clarity and conciseness, description of well-known functions and structures are omitted in the following description.

With the development of intelligent level of products, intelligent products collect various forms of information from a user and then process to provide the user with the processed information for display, and accomplish an interaction with the user. At present, based on a form of an intelligent interaction device, its interaction method is implemented based on voice or gestures, and a display manner of interaction information is implemented by performing information output through a screen or a sound of the intelligent interaction device itself.

In the prior art, forms of interaction devices are different, and based on the differences of the forms of the interaction devices, the interaction manners include the following:

when the interaction device is a speaker with a screen, since the speaker itself has a screen, the speaker with the screen can collect voice information of a user, and feedback interaction information to the user by means of audio and video;

when the interaction device is a TV (intelligent screen), its device can be used to capture user gestures and perform interaction of visual information on the screen based on the gestures;

in addition, when the interaction device is a mobile phone, an AR/VR, acquisition of user gesture instructions can be implemented through hold-held and wearable products, and information interaction with the user is implemented on the screen provided by the mobile phone, AR/VR itself.

However, in the above various forms of the interaction devices, the way of showing or displaying information visually and aurally is relatively fixed. Generally, they pass the interaction information to the user only based on the screen and the sound device carried by the product itself and using a playback mode of a fixed position projection or fixed sound placement direction. Such interaction manner is not flexible enough, the interaction experience brought to the user is poor.

In view of the above problems, the present disclosure provides an interaction method, a device, a system, an electronic device, and a storage medium. The manner for the displayed interaction information of the interaction method is no longer restricted to a screen or a speaker fixed on an interaction device, but can determine the display modeling position of the interaction information based on the user behavior and the user position of the user, and then use the audio and video display device in the environment to perform a display of a corresponding position for the interaction information, its interaction effect with the user is better and the interactivity is stronger.

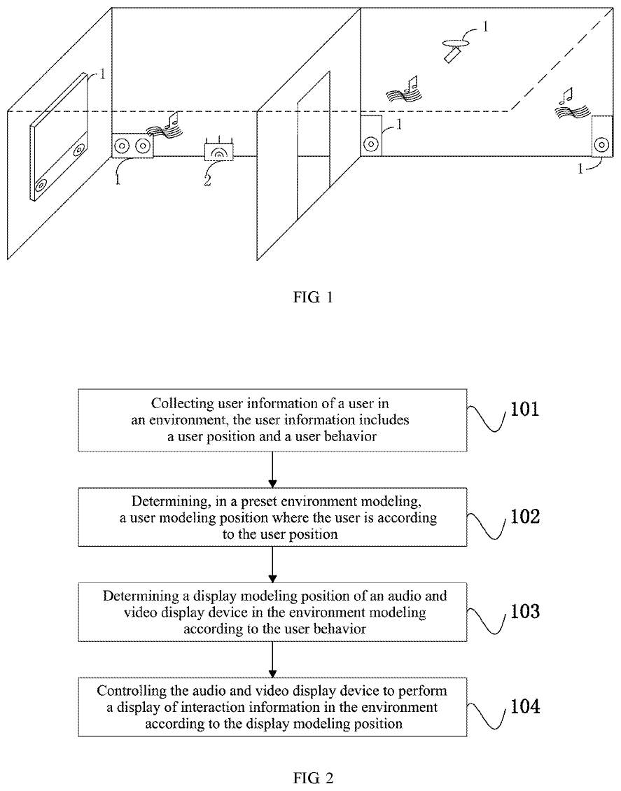

FIG. 1 is a schematic structural diagram of an interaction system provided by the present disclosure. As shown in FIG. 1, the interaction system provided by the present disclosure can be applied to various environments, and is specifically applied to an indoor environment. In the indoor environment, an interaction device 2 and an audio and video display device 1 will be provided. The interaction device 2 may perform any one of the interaction methods described below to control the audio and video display device 1 to perform a display of interaction information in the environment.

The number of the audio and video display device 1 is at least one, and its type is at least one, and positions of each audio and video display device 1 are not limited. As shown in FIG. 1, the audio and video display device 1 includes an intelligent speaker, an intelligent TV, a projection device, and may also include a desktop computer (not shown) and the like. Generally, the positions and display ranges of the each audio and video display device in the environment are relatively fixed. For example, a display range of an image or video of an intelligent TV set in a certain room is a preset range along its light output direction; for example, a display range of an audio of a speaker set in a certain room is a range of the room and the like.

The interaction device 2 is configured to perform the following interaction method, so that each audio and video display device 1 performs the display of the interaction information in the environment based on a control of the interaction device 2. Specifically, the interaction device 2 can have both audio and video display functions, that is, the interaction device can be integrated into the audio and video display device 1 and can also exists independently and be used only as a control terminal. Through wired networks and wireless networks in the environment, the interaction device 2 can perform interaction of information or data with each audio and video display device 1 to achieve corresponding functions.

It should be noted that the manner shown in FIG. 1 is only one of structural and architectural manners provided by the present disclosure. Based on different device types and different environment layouts, the architecture thereof will change accordingly.

In a first aspect, the present disclosure provides an interaction method, and FIG. 2 is a schematic flowchart of an interaction method provided by the present disclosure.

Step 101, collecting user information of a user in an environment, the user information includes a user position and a user behavior.

An executive body of the interaction method according to an example of the present disclosure is an interaction device, where the interaction device may specifically be composed of multiple types of hardware devices, such as a processor, a communicator, an information collector, and a sensor. Different hardware devices play their respective functions during the implementation process of the interaction method to implement the interaction method provided by the present disclosure.

To be specific, firstly a variety of information collectors can be set in the interaction device, including, but not limited to, an audio collector and a vision collector. In the interaction method, the user information of the user in the environment may be collected based on an information collector firstly, and the collected user information includes the user position and the user behavior. Among others, the information collector can be set in the audio and video display device, or it can be set independently. The following example that the information collector is integrated in the audio and video display device is taken as an example to illustrate.

The user position refers to position information of the user in the environment, and it may specifically refer to a position coordinate of the user in the environment. A representation form of the position coordinate may adopt rectangular coordinates, and may also adopt polar coordinates, and world coordinates. The present disclosure does not limit this.

In the examples of the present disclosure, based on the differences of collection technologies on which the interaction device is based, it can determine the user information in different ways:

when the interaction device uses a vision collector to perform collection of the user position, a position image can be obtained by a vision image collection technology, and the position image can be analyzed by using a manner of image position analysis or image coordinate analysis to determine the user position of the user in the environment.

When the interaction device uses an audio collector integrated on the audio and video display device to perform collection of the user position, collection of voice and audio data of the user can be performed, to determine strength of the audio data and an audio and video display device position of the audio and video display device that has collected the audio data. Utilizing that sound will take loss when it propagates in the environment, the position and the strength can be analyzed to determine the user position which initiated the audio data. The audio data can be obtained by collection of multiple audio and video display devices, that is, for a certain voice information initiated by the user, it will include the audio data, the strength of the audio data, and the corresponding device position obtained by collection from multiple audio and video display devices, the user position is obtained by analyzing multiple audio data.

In addition, the aforementioned user behavior refers to behavioral expression of the body of the user, such as the user walking, sitting down, standing still, even making a certain gesture, posing a certain pose, making a certain facial expression. Generally speaking, the user behavior can be obtained by performing data collection and analysis on current total or partial body shape or facial shape of the user through the vision collector. Generally speaking, after user shape data have been collected, it can be obtained by performing analysis of the user shape data based on a recognition model. The recognition model includes, but is not limited to, the following types: a bone recognition model, a gesture recognition model, a facial expression recognition model, a body language recognition model, and the like.

Step 102, determining, in a preset environment modeling, a user modeling position where the user is according to the user position.

Step 103, determining a display modeling position of the audio and video display device in the environment modeling according to the user behavior.

In step 102 and step 103, the interaction device determines a display position where the audio and video display device displays interaction information to the user according to the user position and user behavior, respectively.

Specifically, in order to determine the display position, relevant information of the environment will be collected in advance for performing modeling, and stored in a manner of environment modeling. The environment modeling will include object information including an object position and an object contour of each object in the environment. The way of expression of the object position is similar to that of the user position, which is specifically an object coordinate. The object contour refers to an external contour line of an object, the environment modeling can be formed by using the object information combined with building information of a building itself such as walls.

In a forming process of the environment modeling, it should be noted that the above-mentioned objects include non-audio and video display devices and audio and video display devices, and when the object is an audio and video display device, the environment modeling can also store a display range of the audio and video display device. For example, a display range of an image or video of an intelligent TV in a certain room is a preset range along its light output direction as described above; and a display range of an audio of a speaker set in a room is a range of the room, and the like, so that when providing the interaction information to the user, the audio and video display device that provides the interaction information may be determined based on the display range.

Subsequently, the user position collected in the foregoing step 101 may be used to determine the user modeling position of the user in the environment modeling. That is, in this example, in order to facilitate determination of the display position, a position transformation manner is needed to convert the user position of the user in a real environment to the user modeling position of the user in the environment modeling. The conversion manner can be implemented by using coordinate conversion and the like, and the present disclosure does not limit this.

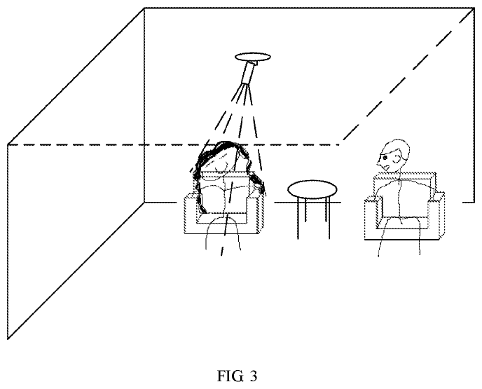

After that, the interaction device will further determine the display modeling position of the audio and video display device in the environment modeling according to the above obtained user behavior combined with the user modeling position. The display modeling position refers to the position coordinate of a display plane of the audio and video display device in the environment modeling when a target audio and video display device that provides an interaction information display to the user provides the interaction information display to the user again. The display plane refers to a presentation plane where audio and video information output by the audio and video display device is located. When the interaction information output by the audio and video display device is an image or a video, its display plane is a projection plane that presents the image or the video (as shown in FIG. 3); when the interaction information output by the audio and video display device is audio, its display plane is an audio receiving plane covering the user position.

Further, determining the display modeling position may adopt the following manner: determining a face pointing of the user according to the user behavior, and then determining the display modeling position of the audio and video display device in the environment according to the face pointing of the user and the user modeling position.

Specifically, as mentioned above, the user behavior refers to the behavioral expression of the user body, and the face pointing thereof can be acquired by performing analysis on the behavioral expression thereof, that is, a user face orientation. According to the user modeling position, a target audio display device for displaying interaction information can be determined. Based on the face pointing and the user modeling position, the display modeling position of the display plane of the target audio and video display device is determined. Specifically, during the modeling, the display range of each audio and video display device can be stored and used to determine the target audio and video display device in this step.

The above display modeling position may specifically include a display plane coordinate and a display attribute, and the corresponding determination of the display modeling position can adopt the following manner:

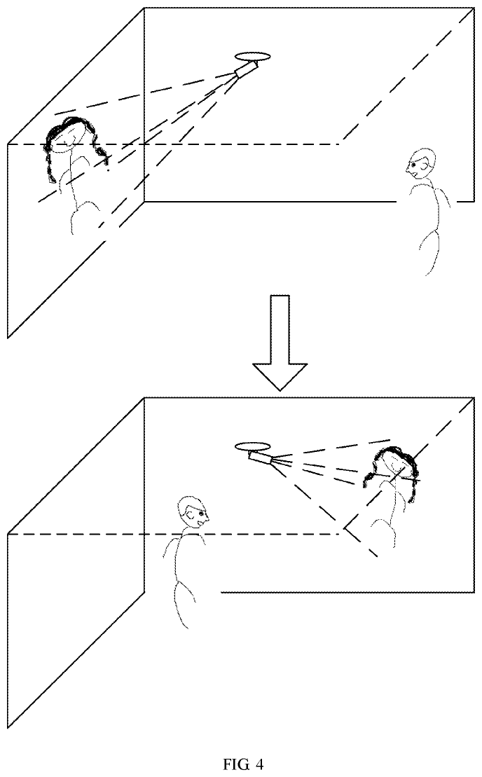

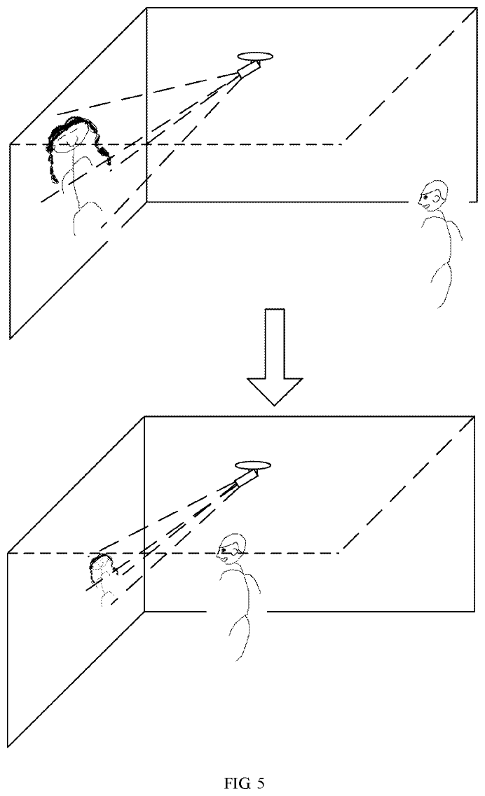

the display plane coordinate of the audio and video display device is determined according to the face pointing of the user, and/or, the user modeling position. As described above, based on different types of the audio and video display devices, the display plane thereof will be different. For example, a display plane coordinate of an audio display device need to include a user coordinate, while a display plane coordinate of a video display device can be determined based on the face pointing of the user and the user modeling position (as shown in FIG. 4).

Subsequently, the display attribute of the audio and video display device when performs a display on the display plane is determined according to a distance between the user and the target audio and video display device. Specifically, the display attributes of different types of audio and video display devices will be different. For example, the display attribute of the audio display device is reflected in audio output strength, while the display attribute of the video display device will be reflected in a display size of audio and video (as shown in FIG. 5). That is, distances between the user and each target audio and video display device are analyzed to determine audio strength output by each audio display device, the display size of the audio and video or a display scale of the audio and video of the video display device.

Among others, the above-mentioned display attribute and display plane coordinate both can be reflected in an environment modeling coordinate.

Step 104, controlling the audio and video display device to perform a display of interaction information in the environment according to the display modeling position.

Based on the determined display modeling position including the display attribute and the display plane coordinate, each audio and video display device to perform the display of the interaction information in the environment is controlled.

FIG. 3 is a first display effect diagram of interaction information of an interaction method provided by the present disclosure. As shown in FIG. 3, the interaction device can collect a behavior and a position of the user sitting on a right sofa, and information with the face facing left, determine a projection device as the audio and video display device, and obtain the display modeling position. Subsequently, based on the display modeling position (such as a left sofa), the projection device is controlled to project the audio and video of a virtual portrait (a left person) on the sofa to obtain the effect shown in FIG. 3.

During an interaction process, the user position and the user behavior may change. The interaction device can collect the user information in real time and control the audio and video display device in real time. FIG. 4 is a second display effect diagram of interaction information of an interaction method provided by the present disclosure, and FIG. 5 is a third display effect diagram of interaction information of an interaction method provided by the present disclosure.

In FIG. 4, the user position of the user is shifted from a right side of the environment to a left side of the environment, and his face orientation is changed from facing left to facing right. At this time, the interaction device can control the projection device shown in FIG. 4 to change its projection plane in real time based on the change of the user information of the user to ensure that the projection plane (display plane) can always match the face orientation of the user, which is convenient for the user to acquire the interaction information.

In FIG. 5, the user position of the user is shifted from a right side of the environment to a left side of the environment, and his face orientation is not modified. At this time, considering that a distance between the user and the projection plane projected by the projection device is relatively short, if an image of the projected virtual character (the left person) is too large, a user perspective is limited, and his viewing will be difficult. At this time, the interaction device will control the projection device to reduce the scale of the display plane of its display attribute to match the user perspective.

In the effect diagrams shown in FIGS. 3-5, the change in the projection plane of the projection device can be based on a pan-tilt on which it is mounted, that is, controlling the pan-tilt to rotate to change the projection plane.

Of course, in other examples, an audio display device at a corresponding position may also be determined based on the user position to provide the user with multi-directional audio display effects.

The above display effect is only exemplary. In the scope of the present disclosure, based on different user behaviors or different user positions, a display manner corresponding to the current state of the user is determined, and the display device is controlled to perform the corresponding display.

The interaction method can be used in a variety of scenarios that there is an audio and video display, such as remote video or teleconference, virtual character interaction, virtual games, and so on.

The interaction method provided by the present disclosure, by collecting user information of a user in an environment, the user information includes a user position and a user behavior; determining, in a preset environment modeling, a user modeling position where the user is according to the user position; determining a display modeling position of an audio and video display device in the environment modeling according to the user behavior; and controlling the audio and video display device to perform a display of interaction information in the environment according to the display modeling position, the manner for the displayed interaction information of the interaction method is no longer restricted to a screen or a speaker fixed on an interaction device, but can determine the display modeling position of the interaction information based on the user behavior and the user position of the user, and then use the audio and video display device in the environment to perform a display of a corresponding position for the interaction information, its interaction effect with the user is better and the interactivity is stronger.

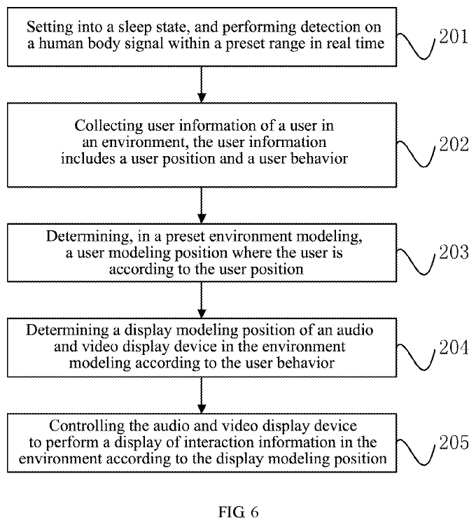

Based on the foregoing examples, FIG. 6 is a schematic flowchart of another interaction method provided by the present disclosure.

Step 201, setting into a sleep state, and performing detection on a human body signal in a preset range in real time;

setting into a working state and performing step 202 when the human body signal is detected.

Step 202, collecting user information of a user in an environment, the user information includes a user position and a user behavior;

step 203, determining, in a preset environment modeling, a user modeling position where the user is according to the user position;

step 204, determining a display modeling position of an audio and video display device in the environment modeling according to the user behavior;

step 205, controlling the audio and video display device to perform a display of interaction information in the environment according to the display modeling position.

Different from the foregoing example, in the interaction method provided by the present disclosure, the interaction device will be set into a sleep state in an initial stage, and in this state, it will not collect the user information such as the user position and the user behavior in the environment. When the interaction device is in the sleep state, it will simultaneously detect human information within a preset range. Specifically, a human sensor such as an infrared sensor and a temperature sensor for detecting the human information may be provided on the interaction device, and the human sensor is used to determine whether there is a user in the environment. Once it is determined that there is a user in the environment, the interaction device will actively initiate and start an interaction based on the foregoing various implementations, that is, when a human signal is detected, the interaction device is set into a working state and begins to collect the user information of the user in the environment. Due to the number of devices involved in the interaction method is large, using such manner can effectively reduce energy consumption of each device involved in the interaction method, and also avoid device loss of the interaction device caused by still performing the user information collection when the user is not in the environment, which improves effective utilization of processing resources and network resources.

The interaction method provided by the present disclosure, by collecting user information of a user in an environment, the user information includes a user position and a user behavior; determining, in a preset environment modeling, a user modeling position where the user is according to the user position; determining a display modeling position of an audio and video display device in the environment modeling according to the user behavior; and controlling the audio and video display device to perform a display of interaction information in the environment according to the display modeling position, the manner for the displayed interaction information of the interaction method is no longer restricted to a screen or a speaker fixed on an interaction device, but can determine the display modeling position of the interaction information based on the user behavior and the user position of the user, and then use the audio and video display device in the environment to perform a display of a corresponding position for the interaction information, its interaction effect with the user is better and the interactivity is stronger.

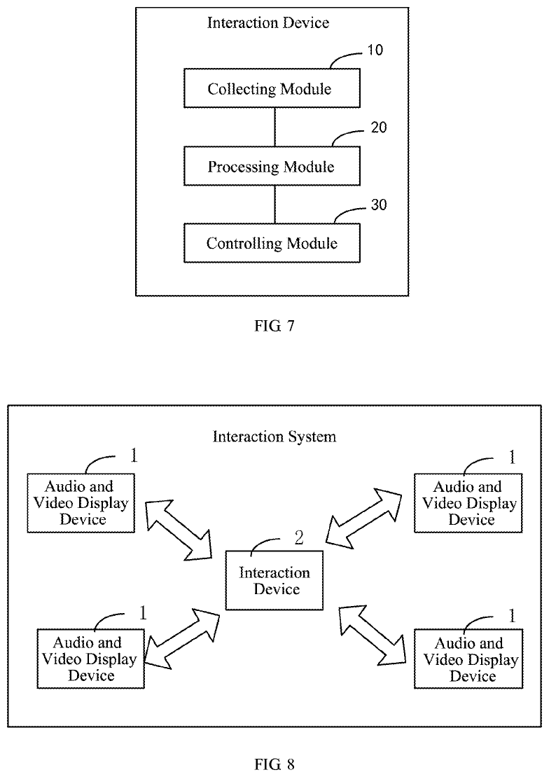

In a second aspect, the present disclosure provides an interaction device, and FIG. 7 is a schematic structural diagram of an interaction device provided by the present disclosure.

As shown in FIG. 7, the interaction device includes:

a collecting module 10, configured to collect user information of a user in an environment, the user information includes a user position and a user behavior;

a processing module 20, configured to determine, in a preset environment modeling, a user modeling position where a user is according to the user position; and is further configured to determine a display modeling position of an audio and video display device in the environment modeling according to the user behavior;

a controlling module 30, configured to control the audio and video display device to perform a display of interaction information in the environment according to the display modeling position.

In an example, the collecting module 10 is further configured to collect object information of each object in the environment before the collecting the user information of the user in the environment, the user information includes the user position and the user behavior, where the object information includes an objects position and an object contour of the object in the environment; where the object includes at least one audio and video display device, and audio and video display device information of the audio and video display device further includes a display range of the audio and video display device;

the processing module 20 is further configured to establish an environment modeling according to the object information of each object.

In an example, the collecting module 10 is specifically configured to collect a user coordinate of the user in the environment through an image collection technology;

correspondingly, the processing module 20 is specifically configured to determine the user modeling position of the user in the environment modeling according to the user coordinate of the user in the environment.

In an example, the collecting module 10 is specifically configured to collect voice information in a user environment by using a voice collection technology, where the voice information includes strength of the voice information and an audio and video display device position of a voice collection audio and video display device that has collected the voice information;

correspondingly, the processing module 20 is specifically configured to determine, according to the strength of the voice information of the user in the environment and the audio and video display device position of the audio capture video display device that has collected the voice information, the user modeling position of the user in the environment modeling.

In an example, the collecting module 10 is specifically configured to collect a body movement of the user for the processing module 20 to determine a face pointing of the user according to the body movement;

the processing module 20 is further configured to determine, according to the face pointing of the user and the user modeling position, a display modeling position of the audio and video display device in the environment modeling.

In an example, the display modeling position includes a display plane coordinate and a display attribute;

the processing module 20 is specifically configured to determine, according to the face pointing of the user, and/or, the user modeling position, the display plane coordinate of the audio and video display device; and determine, according to a distance between the user and the audio and video display device, the display attribute of the audio and video display device when it performs a display on the display plane.

The example also includes an activating module;

the activating module is configured to set the interaction device into a sleep state before the collecting module 10 collects the user information of the user in the environment, the user information includes the user position and the user behavior, and perform detection on a human body signal within a preset range in real time; when a human body signal is detected, the activating module is further configured to set the interaction device into a working state and perform a step of collecting the user information of the user in the environment.

The interaction device provided by the present disclosure, by collecting user information of a user in an environment, the user information includes a user position and a user behavior; determining, in a preset environment modeling, a user modeling position where the user is according to the user position; determining a display modeling position of an audio and video display device in the environment modeling according to the user behavior; and controlling the audio and video display device to perform a display of interaction information in the environment according to the display modeling position, the manner for the displayed interaction information of the interaction method is no longer restricted to a screen or a speaker fixed on an interaction device, but can determine the display modeling position of the interaction information based on the user behavior and the user position of the user, and then use the audio and video display device in the environment to perform a display of a corresponding position for the interaction information, its interaction effect with the user is better and the interactivity is stronger.

In a third aspect, the present disclosure provides an interaction system, and FIG. 8 is a schematic structural diagram of hardware of an interaction system provided by the present disclosure. As shown in FIG. 8, the interaction system includes an interaction device and an audio and video display device; where the interaction device 2 is configured to execute the interaction method according to any one of the foregoing for the audio and video display device 1 to perform a display of interaction information in the environment based on the control of the interaction device 2.

According to an embodiment of the present disclosure, the present disclosure also provides an electronic device and a readable storage medium.

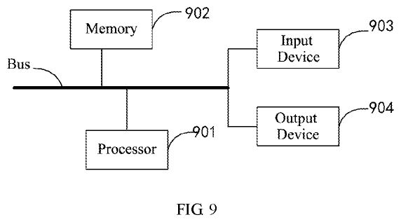

As shown in FIG. 9, it is a block diagram of an electronic device of an interaction method provided by an embodiment of the present disclosure. The electronic device is intended to represent various forms of digital computers, such as a laptop computer, a desktop computer, a workbench, a personal digital assistant, a server, a blade server, a mainframe computer, and other suitable computers. The electronic device may also represent various forms of mobile devices, such as a personal digital processing, a cellular phone, an intelligent phone, a wearable device, and other similar computing devices. The components shown here, their connections and relationships, and their functions are merely examples and are not intended to limit the implementation of the present disclosure described and/or required herein.

As shown in FIG. 9, the electronic device includes: one or more processors 901, a memory 902, and interfaces for connecting various components, including high-speed interfaces and low-speed interfaces. The various components are interconnected using different buses and can be mounted on a common motherboard or otherwise installed as required. The processor may process instructions executed within the electronic device, including instructions stored in or on the memory to display graphical information of Graphical User Interface (GUI) on an external input/output device such as a display device coupled to the interfaces. In other implementations, multiple processors and/or multiple buses can be used together with multiple memories, if desired. Similarly, multiple electronic devices can be connected, each device provides part of the necessary operations (for example, as a server array, a group of blade servers, or a multiprocessor system). One processor 901 is taken as an example in FIG. 9.

The memory 902 is a non-transitory computer-readable storage medium provided by the present disclosure. The memory stores instructions executable by at least one processor, so that the at least one processor executes the interaction methods provided by the present disclosure. The non-transitory computer-readable storage medium of the present disclosure stores computer instructions, the computer instructions is used to cause a computer to execute the interaction methods provided by the present disclosure.

The memory 902, as a non-transitory computer-readable storage medium, can be configured to store non-transitory software programs, non-transitory computer-executable programs, and modules, such as program instructions/modules corresponding to the interaction methods in the embodiments of the present disclosure (for example, the collecting module 10, the processing module 20, and the controlling module 30 shown in FIG. 7). The processor 901 executes various functional applications and data processing of the server by running non-transitory software programs, instructions, and modules stored in the memory 902, that is, methods for implementing the interaction methods in the foregoing method embodiments.

The memory 902 may include a storage program area and a storage data area, where the storage program area may store an operating system and at least one application programs required for functions; the storage data area may store data created according to the use of the electronic device of the interaction method, and the like. In addition, the memory 902 may include a high-speed random access memory, and may also include a non-transitory memory, such as at least one magnetic disk storage device, a flash memory device, or other non-transitory solid-state storage device. In some embodiments, the memory 902 may include a memory remotely disposed with respect to the processor 901, and these remote memories may be connected to the electronic device through a network. Examples of the above network include, but are not limited to, an Internet, an intranet, a local area network, a mobile 902, an input device 903, and an output device 904, which may be connected via a bus or other manners. In FIG. 9, a connection via a bus is taken as an example.

The input device 903 may receive inputted numeric or character information, and generate key signal inputs related to user settings and function control of an electronic device for an interaction method, input devices such as a touch screen, a keypad, a mouse, a trackpad, a touchpad, a pointing stick, one or more mouse buttons, a trackball, a joystick. The output device 904 may include a display device, an auxiliary lighting device (for example, a light emitting diode (LED)), and a haptic feedback device (for example, a vibration motor), and the like. The display device may include, but is not limited to, a liquid crystal display (LCD), a light emitting diode (LED) display, and a plasma display. In some implementations, the display device may be a touch screen.

Various implementations of the systems and technologies described herein may be implemented in a digital electronic circuitry system, an integrated circuit system, an application-specific ASIC (application-specific integrated circuit), computer hardware, firmware, software, and/or combinations thereof. These various implementations may include: implemented in one or more computer programs, the one or more computer programs are executable and/or interpreted on a programmable system including at least one programmable processor, the programmable processor may be a dedicated or general-purpose programmable processor that may receive data and instructions from a storage system, at least one input device, and at least one output device, and transmit the data and instructions to the storage system, the at least one input device, and the at least one output device.

These computing programs (also known as programs, software, software applications, or codes) include machine instructions of a programmable processor and can be implemented by using high-level procedures and/or object-oriented programming languages, and/or assembly/machine languages. As used herein, the terms “machine-readable medium” and “computer-readable medium” refer to any computer program product, device, and/or apparatus used to provide machine instructions and/or data to a programmable processor (for example, a magnetic disk, an optical disk, a memory, a programmable logic device (PLD)), including, machine-readable medium that receive machine instructions as machine-readable signals. The term “machine-readable signal” refers to any signal used to provide machine instructions and/or data to a programmable processor.

To provide interaction with the user, the systems and technologies described herein can be implemented on a computer that has a display device (for example, a CRT (cathode ray tube) or a LCD (liquid crystal display) monitor) for displaying information to the user; and a keyboard and pointing device (such as a mouse or a trackball) through which the user can provide input to the computer. Other kinds of apparatus may also be used to provide interaction with the user; for example, the feedback provided to the user may be any form of sensor feedback (for example, visual feedback, auditory feedback, or haptic feedback); and may be in any form (including acoustic input, voice input, or tactile input) to receive input from the user.

The systems and technologies described herein can be implemented in a computing system that includes back-end components (for example, as a data server), or a computing system that includes middleware components (for example, an application server), or a computing system that includes front-end components (for example, a user computer with a graphical user interface or a web browser through which the user can interact with the implementation of the systems and technologies described herein), or a computing system that includes any combination of such back-end components, middleware components, or front-end components. The components of the systems may be interconnected by any form or medium of digital data communication (for example, a communication network). Examples of communication networks include: local area network (LAN), wide area network (WAN), and Internet.

The computer system may include a client side and a server. The client side and the server are generally remote from each other and typically interact through a communication network. A relationship of the client side and the server is generated by computer programs running on a corresponding computer and having a client side-server relationship with each other.

It should be understood that various forms of processes shown above can be used to reorder, add, or delete steps. For example, various steps recorded in the present disclosure can be executed in parallel, sequentially, or in different orders. As long as the desired results of the technical solutions disclosed in the present disclosure can be achieved, there is no limitation herein.

The foregoing specific implementations do not constitute a limitation of the protection scope of the present disclosure. It should be understood by those skilled in the art that various modifications, combinations, sub-combinations, and substitutions may be made according to design requirements and other factors. Any modification, equivalent replacement, and improvement made within the spirit and principle of the present disclosure shall be included in the protection scope of the present disclosure.

What is claimed is:

1. An interaction method, comprising:
collecting user information of a user in an environment, the user information comprises a user position and a user behavior;
determining, in a preset environment modeling, a user modeling position where the user is according to the user position;
determining a display modeling position of an audio and video display device in the environment modeling according to the user behavior; and
controlling the audio and video display device to perform a display of interaction information in the environment according to the display modeling position.

2. The interaction method according to claim 1, wherein before the collecting user information of a user in an environment, further comprises:
collecting object information of each object in the environment, the object information comprises an object position and an object contour of the object in the environment; and
establishing the environment modeling according to the object information of each object.

3. The interaction method according to claim 1, wherein the collecting user information of a user in an environment, comprises:
collecting a position image of the user in the environment through an image collection technology, and performing image analysis on the position image to obtain the user position.

4. The interaction method according to claim 1, wherein the collecting user information of a user in an environment, comprises:
collecting voice information of the user in the environment through a voice collection technology, the voice information comprises strength of the voice information and an audio and video display device position of a voice collection audio and video display device that has collected the voice information; and
determining the user position according to the strength of the voice information of the user in the environment and the audio and video display device position of the voice collection audio and video display device that has collected the voice information.

5. The interaction method according to claim 1, wherein the determining a display modeling position of an audio and video display device in the environment modeling according to the user behavior, comprises:
determining a face pointing of the user according to the user behavior; and
determining, according to the face pointing of the user and the user modeling position, the display modeling position of the audio and video display device in the environment modeling.

6. The interaction method according to claim 5, wherein the display modeling position comprises a display plane coordinate and a display attribute;
correspondingly, the determining the display modeling position of the audio and video display device in the environment modeling according to the face pointing of the user and the user modeling position, comprises:
determining, according to the face pointing of the user, and/or, the user modeling position, the display plane coordinate of the audio and video display device; and
determining, according to a distance between the user and the audio and video display device, the display attribute of the audio and video display device when performing a display on a display plane.

7. The interaction method according to claim 1, wherein before the collecting user information of a user in an environment, further comprises:
setting into a sleep state, and performing detection on a human body signal within a preset range in real time;
setting into a working state and performing the step of collecting user information of a user in the environment when the human body signal is detected.

8. An interaction device, comprising:
at least one processor; and
a memory stores instructions executable by the at least one processor, wherein, the at least one processor is configured to
collect user information of a user in an environment, the user information comprises a user position and a user behavior;
determine, in a preset environment modeling, a user modeling position where the user is according to the user position; and further determine a display modeling position of an audio and video display device in the environment modeling according to the user behavior; and
control the audio and video display device to perform a display of interaction information in the environment according to the display modeling position.

9. The interaction device according to claim 8, wherein the at least one processor is further configured to collect object information of each object in the environment before collecting the user information of the user in the environment, the object information comprises an object position and an object contour of the object in the environment; wherein the object comprises at least one audio and video display device, and audio and video display device information of the audio and video display device further comprises a display range of the audio and video display device; and
the at least one processor is further configured to establish the environment modeling according to the object information of each object.

10. The interaction device according to claim 8, wherein the at least one processor is configured to collect a user coordinate of the user in the environment through an image collection technology;
correspondingly, the at least one processor is configured to determine, according to the user coordinate of the user in the environment, a user modeling position of the user in the environment modeling.

11. The interaction device according to claim 8, wherein the at least one processor is configured to collect voice information of the user in the environment through a voice collection technology, and the voice information comprises strength of the voice information and an audio and video display device position of a voice collection audio and video display device that has collected the voice information;
correspondingly, the at least one processor is configured to determine, according to the strength of the voice information of the user in the environment and the audio and video display device position of the voice collection audio and video display device that has collected the voice information, the user modeling position of the user in the environment.

12. The interaction device according to claim 8, wherein the at least one processor is configured to collect a body movement of the user to determine a face pointing of the user according to the body movement; and
the at least one processor is further configured to determine, according to the face pointing of the user and the user modeling position, the display modeling position of the audio and video display device in the environment modeling.

13. The interaction device according to claim 12, wherein the display modeling position comprises a display plane coordinate and a display attribute;
the at least one processor is configured to determine, according to the face pointing of the user, and/or, the user modeling position, the display plane coordinate of the audio and video display device; and determine, according to a distance between the user and the audio and video display device, the display attribute of the audio and video display device when performing a display on a display plane.

14. The interaction device according to claim 8, wherein,
the at least one processor is configured to set the interaction device into a sleep state before collecting the user information of the user in the environment, and perform detection on a human body signal within a preset range in real time; and the at least one processor is further configured to set the interaction device into a working state and perform a step of collecting the user information of the user in the environment when the human body signal is detected.

15. An interaction system, comprising: an interaction device and an audio and video display device;
wherein the interaction device is configured to execute the method of claim 1 for the audio and video display device to perform a display of interaction information in an environment based on a control of the interaction device.

16. A non-transitory computer-readable storage medium storing computer instructions, the computer instructions are used to cause a computer to execute the following steps:
collecting user information of a user in an environment, the user information comprises a user position and a user behavior;
determining, in a preset environment modeling, a user modeling position where the user is according to the user position;
determining a display modeling position of an audio and video display device in the environment modeling according to the user behavior; and
controlling the audio and video display device to perform a display of interaction information in the environment according to the display modeling position.

17. The storage medium according to claim 16, wherein before the collecting user information of a user in an environment, the computer instructions are further used to cause the computer to execute the following steps:
collecting object information of each object in the environment, the object information comprises an object position and an object contour of the object in the environment; and
establishing the environment modeling according to the object information of each object.

18. The storage medium according to claim 16, wherein the computer instructions are further used to cause the computer to execute the following steps:
collecting a position image of the user in the environment through an image collection technology, and performing image analysis on the position image to obtain the user position.

19. The storage medium according to claim 16, wherein the computer instructions are further used to cause the computer to execute the following steps:
collecting voice information of the user in the environment through a voice collection technology, the voice information comprises strength of the voice information and an audio and video display device position of a voice collection audio and video display device that has collected the voice information; and
determining the user position according to the strength of the voice information of the user in the environment and the audio and video display device position of the voice collection audio and video display device that has collected the voice information.

20. The storage medium according to claim 16, wherein the computer instructions are further used to cause the computer to execute the following steps:
determining a face pointing of the user according to the user behavior; and
determining, according to the face pointing of the user and the user modeling position, the display modeling position of the audio and video display device in the environment modeling.
